(19) United States
(12) Patent Application Publication
(10) Pub. No.: US 2026/0111041 A1
(43) Pub. Date: Apr. 23, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Toshiya ARAI, Osaka Fu (JP); Yusuke KUSHIKI, Osaka Fu (JP)

(73) Assignee: Panasonic Intellectual Property Management Co., Ltd., Osaka (JP)

(21) Appl. No.: 19/423,816

(22) Filed: Dec. 17, 2025

Related U.S. Application Data
(63) Continuation of application No. PCT/JP2025/006413, filed on Feb. 25, 2025.
(60) Provisional application No. 63/653,095, filed on May 29, 2024.

(51) Int. Cl. G05D 1/692; G05D 1/43; G08G 1/00

(52) U.S. Cl. CPC G05D 1/692; G05D 1/43; G08G 1/20

(57) ABSTRACT

An information processing method is implemented by a computer of an information processing system. The information processing system serves to manage operation of autonomous vehicles traveling in a specific area in which one or more target objects are present. The method includes acquiring operation information relating to the autonomous vehicles in the specific area. The method includes defining a reference distance for each of the autonomous vehicles. The reference distance varies with the operation information. The method includes acquiring position information of the autonomous vehicles being traveling. The method includes causing one of the autonomous vehicles and the target object to coordinate with each other. The one of the autonomous vehicles is an autonomous vehicle whose distance to the target object is equal to or less than the reference distance.

### CROSS-REFERENCE TO RELATED APPLICATIONS

This application is a continuation of International Application No. PCT/JP2025/006413, filed on February 25, 2025, which designates the United States and which claims the benefit of U.S. Provisional Application No. 63/653,095, filed on May 29, 2024, each of which is incorporated by reference herein in its entirety.

### FIELD

Embodiments described herein relate generally to an information processing method, an information processing device, and a recording medium.

### BACKGROUND

Fleet management systems (FMS) have been known, which serve to manage operation of autonomous vehicles in specific areas such as public roads, factories, airports, and ports. In such a FMS, an operation plan is generated in consideration of tasks and facility information, and the behavior and operation of autonomous vehicles are performed based on the generated plan. Therefore, efficient operation of a plurality of autonomous vehicles is desired while ensuring consistency among the autonomous vehicles, infrastructure facilities, and the operation plan.

As a related art, for example, Japanese Patent No. 6742224 discloses a technique that identifiers are assigned to a plurality of autonomous vehicles and intermediation is performed to enable direct communication with other autonomous vehicles within a specified geographical proximity, thereby allowing information exchange among autonomous vehicles.

For another example, Japanese Patent Publication No. 2020-140531 discloses a technique that an infrastructure-coordination zone is determined for coordination operation between an in-vehicle device and an infrastructure sensor, and the coordination operation is started or stopped in the determined infrastructure-coordination zone, thereby achieving driving support for a vehicle in accordance with the installation status of infrastructure sensors.

When cooperating autonomous vehicles with infrastructure facilities, it is desirable to perform direct communication between them in view of perspective of responsiveness according to surrounding conditions and traveling situations. However, there is a problem that it is difficult to ensure consistency with other vehicles traveling in the vicinity and with operation plans.

Moreover, in a case where instructions are given from the FMS to the autonomous vehicles in accordance with information about the infrastructure facilities, or in a case where instructions are given to the infrastructure facilities in accordance with the operation plan, there is a problem that responsiveness is impaired.

Therefore, there is room for improving both efficiency and responsiveness with respect to consistency between autonomous vehicles and target objects such as infrastructure facilities and transported cargo.

### SUMMARY

An information processing method according to one aspect of the present disclosure is implemented by a computer of an information processing system. The information processing system serves to manage operation of autonomous vehicles traveling in a specific area in which one or more target objects are present. The method includes acquiring operation information relating to the autonomous vehicles in the specific area. The method includes defining a reference distance for each of the autonomous vehicles. The reference distance varies with the operation information. The method includes acquiring position information of the autonomous vehicles being traveling. The method includes causing one of the autonomous vehicles and the target object to coordinate with each other. The one of the autonomous vehicles is an autonomous vehicle whose distance to the target object is equal to or less than the reference distance.

### BRIEF DESCRIPTION OF THE DRAWINGS

FIG. 1 is a diagram illustrating an exemplary schematic configuration of an integrated management system according to an embodiment;

FIG. 2 is a diagram illustrating an exemplary hardware configuration of an information processing device that implements respective functions of devices included in the integrated management system according to an embodiment;

FIG. 3 is a sequence diagram illustrating an exemplary procedure of information processing executed by the integrated management system according to an embodiment;

FIG. 4 is a diagram illustrating an exemplary coordination zone for each vehicle in the integrated management system according to an embodiment;

FIG. 5 is a flowchart illustrating an exemplary procedure of intermediary processing executed by a fleet management system according to an embodiment;

FIG. 6 is a flowchart illustrating an exemplary procedure of coordination zone creation processing executed by the fleet management system according to an embodiment;

FIG. 7 is a diagram illustrating an example of coordination zone size information based on importance of operation task according to an embodiment;

FIG. 8 is a diagram illustrating an example of connection information according to an embodiment;

FIG. 9 is a flowchart illustrating an exemplary procedure of coordination zone update processing executed by the fleet management system according to an embodiment;

FIG. 10 is a sequence diagram illustrating another exemplary procedure of information processing executed by the fleet management system according to an embodiment;

FIG. 11 is a diagram illustrating an exemplary application scenario of the integrated management system according to an embodiment;

FIG. 12 is a diagram illustrating another exemplary application scenario of the integrated management system according to an embodiment; and

FIG. 13 is a diagram illustrating still another exemplary application scenario of the integrated management system according to an embodiment.

### DETAILED DESCRIPTION

Hereinafter, embodiments of an information processing method, an information processing device, an information processing system, a mobile body, a program, and a recording medium according to the present disclosure will be described in detail with reference to the accompanying drawings.

Moreover, in the description of the present disclosure, components having the same or substantially the same functions as those previously described with respect to the aforementioned figures may be denoted by the same reference numerals, and a description thereof may be omitted as appropriate. Even when representing the same or substantially the same parts, the relative dimensions or ratios may be represented differently in the drawings. In addition, from the viewpoint of ensuring visibility of the drawings, only main components may be given reference numerals in the description of each drawing, and components having the same or substantially the same functions as those described in a previously-presented figure may sometimes not be given reference numerals.

Moreover, in the description of the present disclosure, components having the same or substantially the same functions may be distinguished by appending alphanumeric characters and/or symbols to the end of their reference numerals. Alternatively, in a case where a plurality of components having the same or substantially the same functions are not to be distinguished, the appended alphanumeric characters and/or symbols at the ends of the reference numerals may be omitted and the components may be collectively denoted.

Conventionally, in the field of autonomous driving, specific autonomous vehicles have been considered and used according to the intended implementation. In particularly limited premises where autonomous vehicles are operated for business purposes, a transition is expected from operation with a single autonomous vehicle to operation with multiple autonomous vehicles so as to improve business efficiency. In such operation with multiple autonomous vehicles, not only physical cooperation among vehicles is required, but also management of multiple vehicle types and cooperation with different facilities and the like are demanded.

However, in a case of multiple types of autonomous vehicles, different vehicle types can coexist according to the task (business purpose). In addition, the relevant control signals and control methods can differ among the vehicle types. The business operators (business providers) thereof can differ. For this reason, a challenge in operating multiple types of autonomous vehicles lies in the fact that they are generally not treatable in a uniform manner.

Considering the circumstances above, an integrated management system according to an embodiment disclosed herein is configured to execute an information processing method that converts business of a business provider into transportation tasks in order to centrally handle different businesses and vehicle types, thereby managing the autonomous driving of different vehicle types. More specifically, the integrated management system according to an embodiment disclosed herein is configured to execute an information processing method that appropriately manages the operation of autonomous vehicles in cooperation with external target objects such as infrastructure facilities including traffic lights, transported cargo, or the like.

### First Embodiment

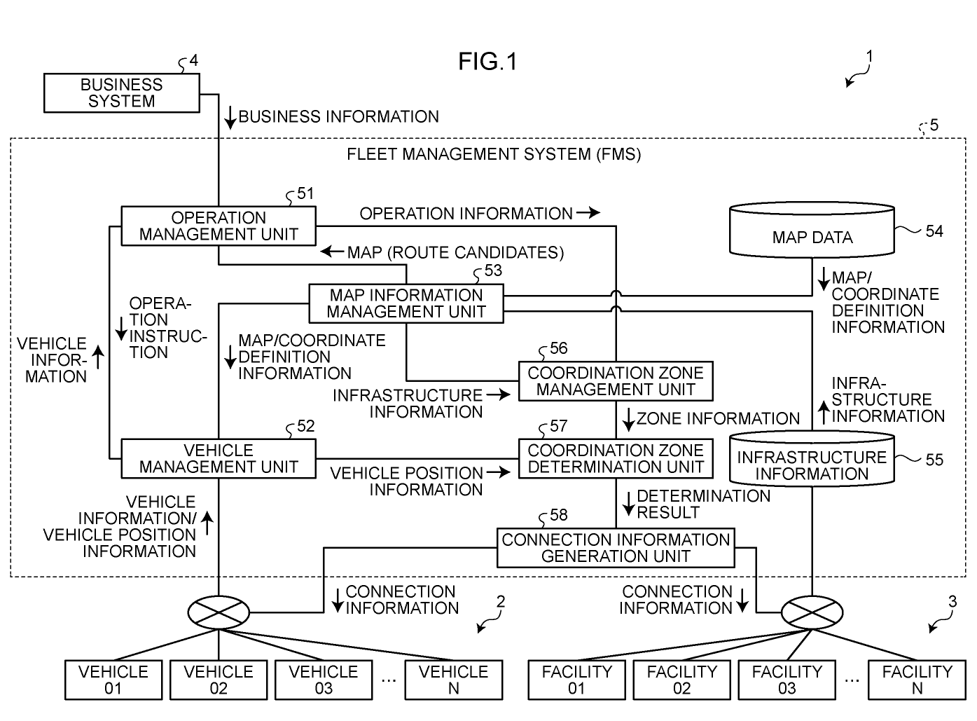

FIG. 1 is a diagram illustrating an exemplary schematic configuration of an integrated management system 1 according to an embodiment. As illustrated in FIG. 1, the integrated management system 1 includes one or more vehicles 2, one or more facilities 3, a business system 4, and a fleet management system (FMS) 5.

Each of the vehicles 2 is an example of a mobile body that performs various tasks including autonomous traveling (automated driving) related to various services such as delivery, security, cleaning, childcare, nursing care, sales, farming, manufacturing, cargo loading and unloading, transportation, construction, etc. In one example, the vehicle 2 is a mobile body configured to autonomously travel and perform a predetermined task. Moreover, the vehicle 2 can also be configured to travel and perform the predetermined task in accordance with remote instructions or remote operation from an operator or a management system that monitors a plurality of vehicles 2 or direct operation from a driver.

Moreover, each of the vehicles 2 can be, for example, a four-wheeled vehicle or a two-wheeled vehicle. Each vehicle 2 can also be, for example, an automatic guided vehicle (AGV), or various types of mobile bodies such as construction machinery, agricultural machinery, or drones. The mobile bodies mentioned above are not limited to serve to transport people, but can transport objects other than people, or can provide specific services other than transportation.

Each of the facilities 3 is one of various types of facility located in a specific area in which at least one of the vehicles 2 travels. The term "specific area" used herein refers to a predetermined area, such as a public road, a factory, an airport, or a port, in which at least one target object is present. In addition, the specific area is also a predetermined area targeted for management of the operation of the vehicle 2 (autonomous vehicle) traveling within the area. Each of the facilities 3 can be an infrastructure facility such as a traffic light, an automatic door or a gate, or a facility such as a cargo management system or a terminal on an emergency vehicle. In the present embodiment, a traffic light (infrastructure facility) at an intersection on the operation route of the vehicle 2 (autonomous vehicle) in a specific area (e.g., an airport) is primarily exemplified.

The business system 4 is an information processing system operated by a business provider that provides business services such as cargo transportation or passenger transportation through traveling of the vehicles 2. The business system 4 transmits relevant business information to the fleet management system 5. The business information includes, for example, a request for cargo transportation. In one example, the business information includes information about cargos to be transported and information indicating the source and destination of each of the cargos.

The fleet management system 5 is an information processing system operated by a business provider that manages different types of autonomous vehicles. The fleet management system 5 is configured to be communicably connected to the business system 4 via a telecommunication line (network). The fleet management system 5 is also configured to be communicably connected to each of the vehicles 2 via a telecommunication line (network). The fleet management system 5 is configured to be communicably connected to each of the facilities 3 via a telecommunication line (network).

The fleet management system 5 includes an operation management unit 51, a vehicle management unit 52, a map information management unit 53, map data 54, infrastructure information 55, a coordination zone management unit 56, a coordination zone determination unit 57, and a connection information generation unit 58.

The operation management unit 51 acquires business information from the business system 4, map information from the map information management unit 53, and vehicle information from the vehicle management unit 52. The map information from the map information management unit 53 can be information regarding a route candidate. In addition, the operation management unit 51 converts business of the business provider into movement tasks based on the business information, map information, and vehicle information, and formulates a vehicle operation plan for the vehicle 2. The operation management unit 51 also supplies an operation instruction according to the formulated operation plan to the vehicle management unit 52. Additionally, the operation management unit 51 also supplies operation information according to the formulated operation plan to the coordination zone management unit 56.

The vehicle management unit 52 acquires the operation instruction from the operation management unit 51, map and coordinate definition information from the map information management unit 53, and vehicle information and vehicle position information from each of the vehicles 2. The vehicle management unit 52 manages the operation of the vehicles 2 in a specific area based on the operation instruction, the map and coordinate definition information, the vehicle information, and the vehicle position information. The vehicle management unit 52 supplies the vehicle information for each of the vehicles 2 to the operation management unit 51. In addition, the vehicle management unit 52 also supplies the vehicle position information for each of the vehicles 2 targeted by the operation instruction to the coordination zone determination unit 57.

The term "vehicle information" described herein includes, for example, an image captured by a camera installed in the vehicle 2 and vehicle body information. The vehicle body information can include sensor information supplied from a system such as light detection and ranging (LiDAR), radar, sonar, or a global navigation satellite system (GNSS) including a global positioning system (GPS) provided in the body of the vehicle 2, as well as sensing information such as target object information, position information, or map information processed from the sensor information.

The map information management unit 53 manages the map data 54 and the infrastructure information 55. The map information management unit 53 acquires map and coordinate definition information stored in the map data 54 and infrastructure information stored in the infrastructure information 55. The map information management unit 53 supplies, to the operation management unit 51, the map and coordinate definition information, or map information that is based on the map and coordinate definition information. In addition, the map information management unit 53 also supplies the map and coordinate definition information to the vehicle management unit 52. Furthermore, the map information management unit 53 also supplies the infrastructure information to the coordination zone management unit 56.

The map data 54 is a database that stores the map and coordinate definition information. The map and coordinate definition information can be coordinate information that defines travel roads and positions of structures in a specific area.

The infrastructure information 55 is a database that stores information indicating position information and operational roles of each of the facilities. The infrastructure information 55 (database) is configured to be communicably connected to each of the facilities 3 via a telecommunication line (network). In addition, the infrastructure information 55 acquires a status of each facility 3 through communication with the facilities 3 and updates the infrastructure information accordingly.

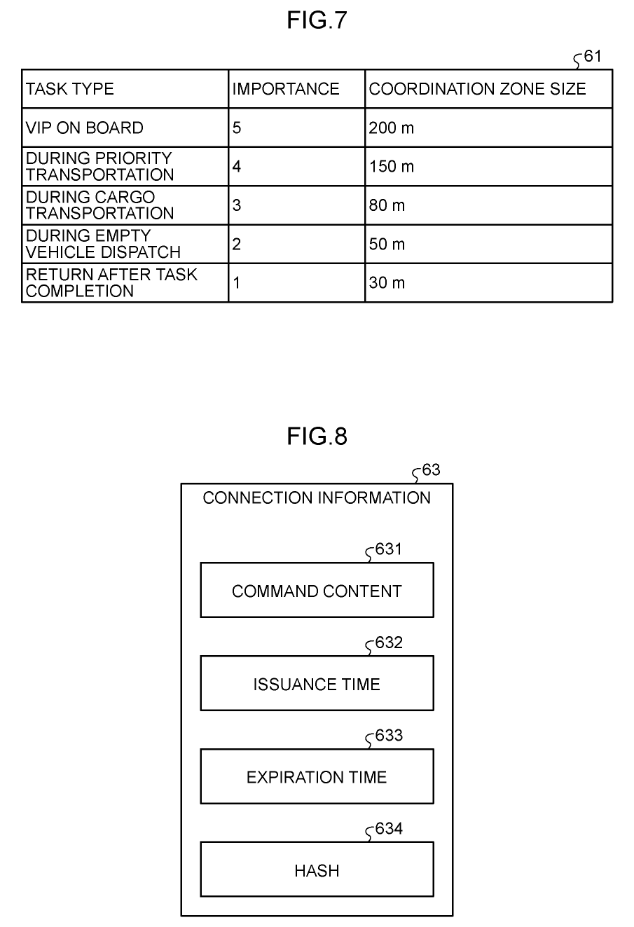

The coordination zone management unit 56 acquires the operation information according to the operation plan from the operation management unit 51 and the infrastructure information from the map information management unit 53. The coordination zone management unit 56 generates a coordination zone for each of the vehicles 2 included in the operation information, based on the operation information and the infrastructure information. The term "coordination zone" used herein refers to a range in which a distance between the vehicle 2 and the facility 3 (target object) is equal to or less than a reference distance. Additionally, the term "coordination zone" defines a range in which the vehicle and the facility are coordinated with each other. The reference distance is a distance that varies with the operation information and is defined for each vehicle 2. In one example, the coordination zone management unit 56 generates, for each vehicle 2, a coordination zone with the size based on coordination zone size information (see FIG. 7). Moreover, the coordination zone size information can be predetermined and held by the coordination zone management unit 56 or stored in an internal memory of the fleet management system 5. The coordination zone management unit 56 supplies zone information indicating the coordination zone to the coordination zone determination unit 57.

The operation information supplied from the operation management unit 51 to the coordination zone management unit 56 includes, for example, business task information, operation plan information, and authentication information. The business task information includes information regarding a task objective such as flight arrival, flight departure, pickup, drop-off, and return. In addition, the business task information includes information regarding task importance, such as priority and urgency of the transported object and priority of the task itself. The operation plan information includes route information, destination information, and distance-to-destination information. The operation plan information includes object-side position information and object role information. The authentication information includes information regarding vehicle type and vehicle passage authorization. The authentication information also includes object identification information. Note that these pieces of information are merely examples and can be modified as appropriate.

The coordination zone determination unit 57 acquires the zone information from the coordination zone management unit 56 and acquires the vehicle position information about at least one of the vehicles 2, which is the target of an operation instruction from the vehicle management unit 52. The coordination zone determination unit 57 determines the entry of the vehicle 2 into a coordination zone based on the zone information and the vehicle position information. The coordination zone determination unit 57 supplies the determination result to the connection information generation unit 58.

The connection information generation unit 58 acquires the determination result from the coordination zone determination unit 57 indicating whether the vehicle 2 enters the coordination zone. When the vehicle 2 enters the coordination zone, the connection information generation unit 58 generates connection information (see FIG. 8) for each of the relevant vehicle 2 and facility 3. The connection information mentioned above is information used for determining the consistency of a connection request. The connection information generation unit 58 supplies the connection information to each of the relevant vehicle 2 and facility 3.

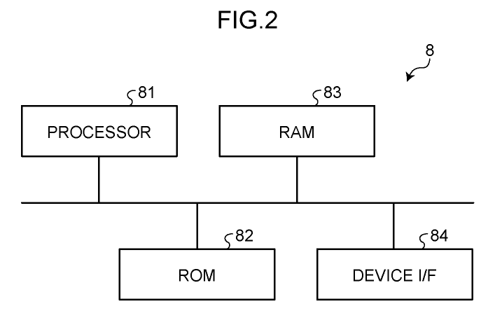

FIG. 2 is a diagram illustrating an exemplary hardware configuration of an information processing device that implements respective functions of devices included in the integrated management system 1 according to an embodiment. The information processing device 8 is a computer that integrally controls the overall operation of each device included in the integrated management system 1.

Moreover, the information processing device 8, which implements each function of the vehicle 2, can be a computer such as an electronic control unit (ECU) installed inside the vehicle 2, a domain control unit (DCU) such as a cockpit domain controller (CDC) that integrates multiple ECUs, or an on-board unit (OBU).

As illustrated in FIG. 2, the information processing device 8 includes a processor 81, a read-only memory (ROM) 82, a random-access memory (RAM) 83, and a device interface (I/F) unit 84.

The processor 81 is, for example, a central processing unit (CPU). In addition to or instead of the CPU, the processor 81 is at least one of various processors such as a graphics processing unit (GPU), an application-specific integrated circuit (ASIC), or a field-programmable gate array (FPGA) can be appropriately utilized. The processor 81 according to the embodiment is an example of a hardware processor provided in the information processing device 8.

In one example, the processor 81 of the fleet management system 5 executes a program stored in the ROM 82 to implement the functions of the operation management unit 51, the vehicle management unit 52, the map information management unit 53, the coordination zone management unit 56, the coordination zone determination unit 57, and the connection information generation unit 58 illustrated in FIG. 1. Note that, although the example in FIG. 1 illustrates only the functions sufficient for describing the main parts of embodiments, the functions of each device included in the integrated management system 1 are not limited thereto.

In the embodiment, the processor 81 executes a program stored in the ROM 82 to implement each function of each device, including the functions of the above-mentioned components. However, the present disclosure is not limited thereto, and some or all of these functions can be implemented by dedicated hardware circuits. In addition, two or more functions can be integrated and implemented as one function in each device of the integrated management system 1. Similarly, in each device of the integrated management system 1, one function can be divided and implemented as two or more functions. In the integrated management system 1, the functions of two or more devices can be integrated and implemented as at least one function of one of the devices. Similarly, in the integrated management system 1, one function of a device can be divided and implemented as two or more functions of two or more devices.

The ROM 82 is a non-volatile memory and is an auxiliary storage device that stores various types of information, including programs executed by the processor 81. As the memory of the information processing device 8, not only the ROM 82 but also various recording media or recording devices such as a hard disk drive (HDD), a solid-state drive (SSD), or a flash memory can be used as appropriate. The RAM 83 is a volatile memory that provides a working area for the processor 81 and serves as the main storage device. The ROM 82 and the RAM 83 according to the embodiments are an example of a memory provided in the information processing device 8. The device I/F unit 84 is an interface used for connecting each device included in the integrated management system 1 to other devices of the information processing device 8, such as a communication device (not illustrated), a display device (not illustrated), and an input device (not illustrated).

Next, an exemplary operation of the integrated management system 1 configured as described above will be described with reference to the drawings. Note that the operational procedures and processing flow described below are merely examples, and modification of the order of steps, deletion of some steps, and addition of other steps can be made as appropriate.

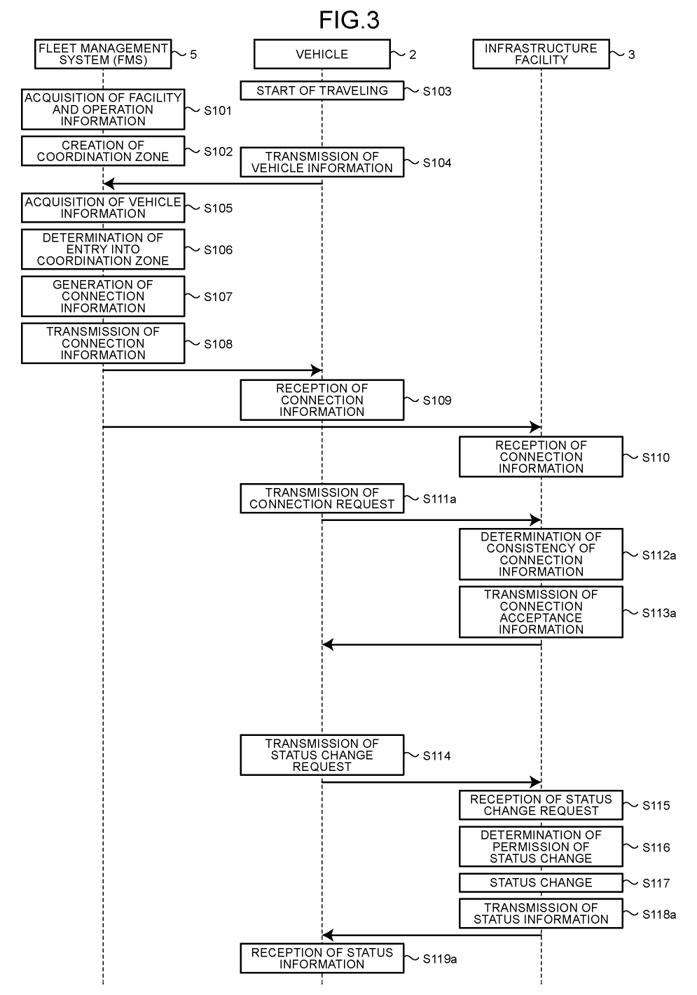

FIG. 3 is a sequence diagram illustrating an exemplary procedure of information processing executed by the integrated management system 1 according to an embodiment.

The fleet management system 5 acquires the infrastructure information relating to the facilities 3 and the operation information relating to the vehicles 2 (S101). The fleet management system 5 generates a coordination zone for each of the vehicles 2 included in the operation information based on the acquired operation information and infrastructure information (S102). In addition, after starting to travel (S103), each of the vehicles 2 transmits the vehicle information to the fleet management system 5 at predetermined intervals (S104). The fleet management system 5 acquires the vehicle information from each vehicle 2 (S105). The fleet management system 5 determines the entry of each vehicle 2 into a coordination zone based on the zone information indicating the coordination zone for each vehicle 2 and the vehicle position information for each vehicle 2 (S106). In response to determining that any of the vehicles 2 enters the coordination zone, the fleet management system 5 generates connection information (S107) and transmits the generated connection information to the relevant vehicle 2 and facility 3 (S108). The relevant vehicle 2 and facility 3 each receive the connection information from the fleet management system 5 (S109 and S110).

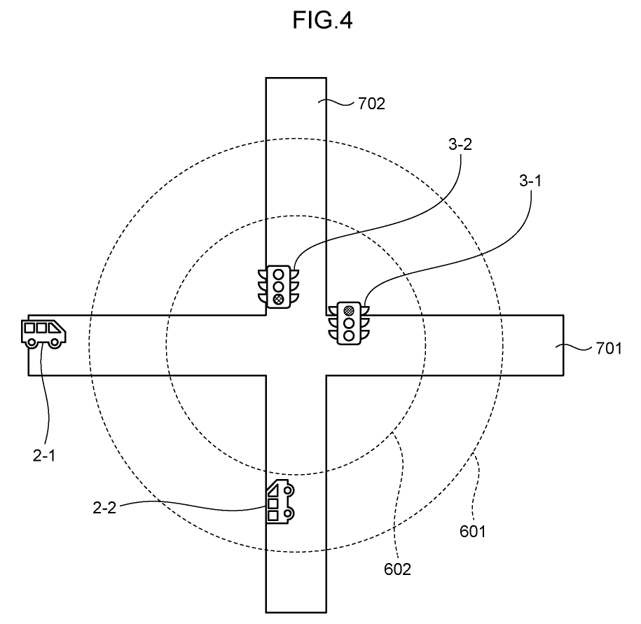

FIG. 4 is a diagram illustrating an example of coordination zones 601 and 602 for each vehicle 2 in the integrated management system 1 according to an embodiment. FIG. 4 illustrates an example of a crossroads intersection at which a first travel road 701 and a second travel road 702 intersect. FIG. 4 exemplifies a first traffic light 3-1 provided at the intersection for the first travel road 701 and a second traffic light 3-2 provided at the intersection for the second travel road 702. In addition, FIG. 4 exemplifies a first vehicle 2-1 traveling toward the intersection on the first travel road 701 and a second vehicle 2-2 traveling toward the intersection on the second travel road 702.

In the example of FIG. 4, the fleet management system 5 generates the coordination zone 601 for the first vehicle 2-1 based on the infrastructure information relating to the first traffic light 3-1 and the operation information relating to the first vehicle 2-1. Similarly, the fleet management system 5 generates the coordination zone 602 for the second vehicle 2-2 based on the infrastructure information relating to the second traffic light 3-2 and the operation information relating to the second vehicle 2-2. In the operation information according to the embodiment, it is assumed that the priority of the first vehicle 2-1 is set to be higher than the priority of the second vehicle 2-2. In this case, as illustrated in FIG. 4, the coordination zone 601 of the first vehicle 2-1 is generated to be larger than the coordination zone 602 of the second vehicle 2-2.

In the example of FIG. 4, the fleet management system 5 does not generate connection information and does not enable coordination even if the second vehicle 2-2 enters the coordination zone 601 of the first vehicle 2-1. On the other hand, the fleet management system 5 generates the connection information and enables coordination when the second vehicle 2-2 enters the coordination zone 602. Similarly, the fleet management system 5 generates the connection information and enables coordination when the first vehicle 2-1 enters the coordination zone 601 of the first vehicle 2-1. With this configuration, the prioritized vehicle (2-1) is able to acquire control authority (request right) earlier than another vehicle (2-2) at a position farther from the traffic light.

The vehicle 2 that has received the connection information, namely, the vehicle 2 with the request right transmits a connection request to the facility 3 that is the target object (S111a). In this processing flow, the connection request refers to a request for control authority over the target object. The facility 3 that has received the connection request determines the consistency of the connection information (S112a). When the consistency is determined to be valid, the facility 3 establishes a connection with the relevant vehicle 2 by transmitting connection acceptance information (S113a) in response to the connection request (S111a) from this vehicle 2. In other words, the vehicle 2 that has received the connection information establishes communication with the relevant facility 3 (target object) based on the connection information.

The vehicle 2 that has received the connection acceptance information coordinates with the target object by transmitting a status change request to the target object (S114). The status change request refers to a request to change the status of the target object. In one example, the status change request can indicate that requesting a traffic light on the travel road of the vehicle to change to a status allowing the vehicle to pass (for example, turn green). Upon receiving the status change request from the vehicle 2 (S115), the facility 3 determines whether or not to allow the status change according to the status change request (S116). When the status change is permitted, the facility 3 changes the status in accordance with the status change request (S117). After performing the status change in accordance with the status change request, the facility 3 transmits status information indicating a status after the change (S118a) in response to the status change request from the vehicle 2. The vehicle 2 receives the status information transmitted from the facility 3 (S119a).

Hereinafter, an exemplary operation of the integrated management system 1 according to the embodiment will be described in more detail.

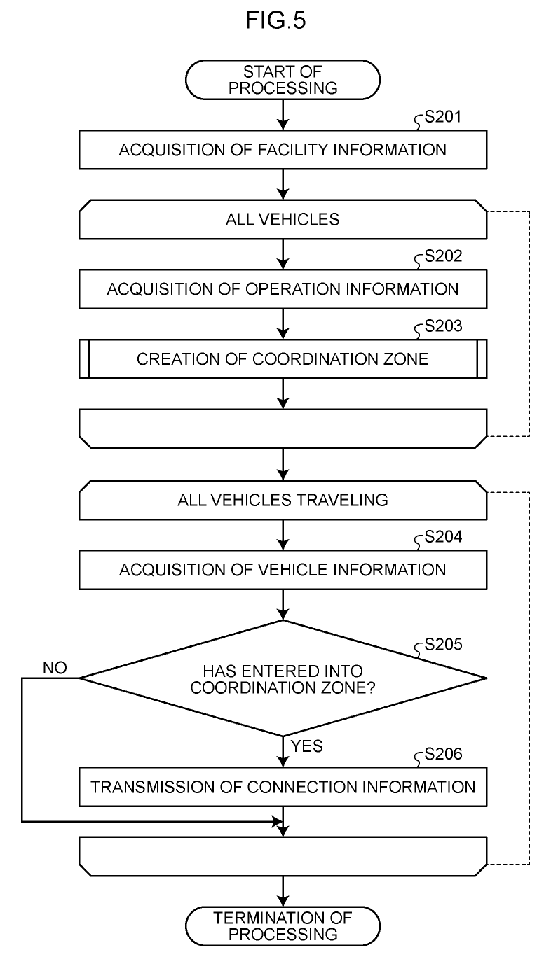

FIG. 5 is a flowchart illustrating an exemplary procedure of the intermediary processing executed by the fleet management system 5 according to the embodiment. The procedure in FIG. 5 exemplifies information processing executed on the side of the fleet management system 5 in the information processing of FIG. 3.

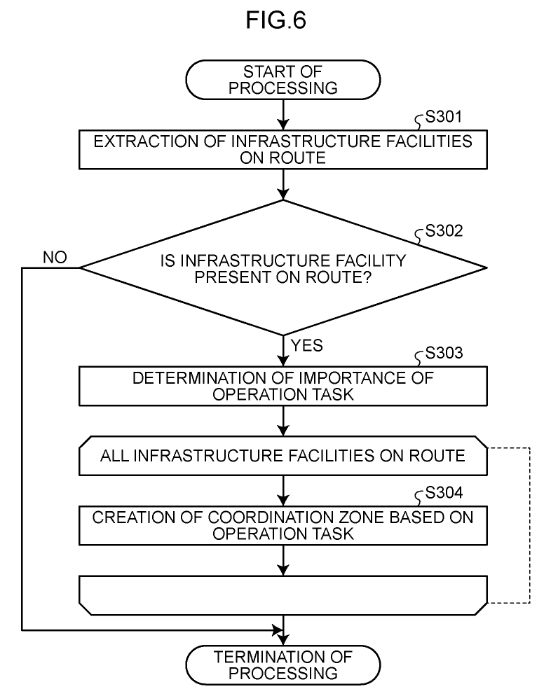

The coordination zone management unit 56 acquires the infrastructure information from the map information management unit 53 (S201). In addition, the coordination zone management unit 56 acquires the operation information for all the vehicles 2 (S202). The coordination zone management unit 56 executes coordination zone creation processing (see FIG. 6) for each vehicle 2 based on the operation information and the infrastructure information (S203). The phrase "all the vehicles 2 for which coordination zones are generated" refers to, for example, all the vehicles 2 included in the operation information, but are not limited thereto. The coordination zone management unit 56 can also acquire the vehicle information from, for example, the vehicle management unit 52 and generate a coordination zone for other vehicles 2.

The processing steps of S201 to S203 are executed, for example, before implementing the operation plan specifying the operation information. While the operation plan is being implemented, the processing steps of S204 to S206 described below are repeatedly executed for each vehicle 2 currently in motion. The vehicles 2 targeted by the processing steps of S204 to S206 refer to, for example, all the vehicles 2 currently in motion included in the operation information, but are not limited thereto. Such vehicles 2 are, for example, vehicles 2 included in the operation information before starting to travel.

The coordination zone determination unit 57 acquires the vehicle information (S204) and determines whether the vehicles 2 enter their respective coordination zones (S205). When there is no vehicle that has entered the coordination zone (S205: No), the procedure of FIG. 5 returns to the processing step of S204 for each vehicle 2 currently in motion and ends processing steps of S204 to S206 for each vehicle 2 that has completed traveling. On the other hand, when there is the vehicle 2 that has entered the coordination zone (S205: Yes), the connection information generation unit 58 generates and transmits the connection information for the relevant vehicle 2 and facility 3 (S206). The procedure in FIG. 5 returns to the processing steps of S204 for each vehicle 2 that is currently traveling, and ends for each vehicle 2 that has completed traveling.

Note that the processing steps of S201-S203 before the operation plan are implemented and the processing steps of S204-S206 during the operation plan can be consecutively executed, or can be executed separately at different times.

FIG. 6 is a flowchart illustrating an exemplary procedure of the coordination zone creation processing executed by the fleet management system 5 according to an embodiment. FIG. 6 exemplifies the coordination zone creation processing (S203 in FIG. 5) for any one vehicle 2. The coordination zone management unit 56 extracts the facility 3 located on the route of the vehicle 2 based on the operation information and the infrastructure information (S301). If no facility 3 is present on the route of the vehicle 2 (S302: No), the procedure of FIG. 6 ends and returns to the procedure of FIG. 5. On the other hand, if at least one facility 3 is present on the route of the vehicle 2 (S302: Yes), the coordination zone management unit 56 determines importance of operation task based on the task information included in the operation information (S303). In addition, the coordination zone management unit 56 creates, based on coordination zone size information 61, coordination zones for all facilities 3 on the route of the vehicle 2 with sizes corresponding to the importance of operation task (S304). After creating coordination zones for all the facilities 3 on the route of the vehicle 2, the procedure in FIG. 6 ends and returns to the procedure of FIG. 5.

FIG. 7 is a diagram illustrating an example of the coordination zone size information 61 based on the importance of operation task according to an embodiment. In one example, the coordination zone size information 61, as illustrated in FIG. 7, is information indicating a relationship, predetermined in advance, among a type of operation task, an importance level, and a coordination zone size. In the example in FIG. 7, the task type of "VIP On Board" is associated with an importance level of "5" and a coordination zone size of "200 m". In addition, the task type "During Priority Transportation" is associated with an importance level of "4" and a coordination zone size of "150 m". Furthermore, the task type "During Cargo Transportation" is associated with an importance level of "3" and a coordination zone size of "80 m". Additionally, the task type "Empty Vehicle Dispatch" is associated with an importance level of "2" and a coordination zone size of "50 m". The task type "Return After Task Completion" is associated with an importance level of "1" and a coordination zone size of "30 m". Note that the configuration of the coordination zone size information 61 in FIG. 7 is merely an example, and the items and correspondences can be modified as appropriate. The coordination zone size (namely, the size of the coordination zone) corresponds to the length of a reference distance.

Moreover, the size of the coordination zone can be defined by using, for example, the number of zones (number of waypoints) on the graph data. The size of the coordination zone can also be defined by using, for example, a distance or the number of zones on the route of the vehicle 2. The size of the coordination zone can be defined by using an arrival time to the facility 3 based on the traveling speed or planned traveling speed of the vehicle 2. Additionally, the size of the coordination zone can also be defined by using a region of a predetermined shape. The predetermined shape of the region can be defined by a plurality of vertices, or a region defined by a figure that can be represented on a map, such as a circle or ellipse. Moreover, the coordination zone can be defined not only in a coordinate system of map information (the specific area), but also in a moving coordinate system centered on the vehicle 2.

The size of the coordination zone can vary with the vehicle type of the vehicle 2, traveling speed or planned traveling speed, and available lanes. The size of the coordination zone can be set to infinity for an emergency vehicle or a vehicle performing an emergency task. In other words, such emergency vehicles and emergency-task vehicles can be treated as always available for connection (coordination at all times).

Moreover, a plurality of coordination zones can also be created for a single vehicle 2. In other words, a plurality of reference distances can be defined for a single vehicle 2. For example, two coordination zones can be created for one vehicle 2 with a larger zone (first reference distance) designated as a pre-request acceptance range for accepting a request (connection request) in advance, and a smaller zone (second reference distance) designated as a range for starting operation (establishing a connection) in response to the request. In addition, the coordination zone can be created, for example, for each vehicle 2, but the coordination zone can also be created for each vehicle type, for each task type, for each traveling speed or planned driving speed (e.g., a coordination zone for 20 km/h and a coordination zone for 5 km/h), or for each traveling lane of the vehicle 2.

The coordination can be performed between a vehicle 2 and another vehicle 2, or can involve business provider's fleet management system (FMS) between them. Alternatively, the coordination can be performed between the business provider's FMS and the facility 3.

Further, rather than a request, a connection intended for obtaining signal information can be enabled without regard to the coordination zone.

FIG. 8 illustrates an example of connection information 63 according to an embodiment. As illustrated in FIG. 8, the connection information 63 can include command content 631, issuance time 632, expiration time 633, and hash 634. In the fleet management system 5, the connection information generation unit 58 generates a command to be issued and applies the hash 634 by using its private key. The vehicle 2 transmits the connection request to the facility 3 at desired timing. Upon receiving it, the facility 3 determines the consistency of the connection information 63 by using a certificate (public key) of the fleet management system 5.

As described above, the integrated management system 1 according to the present embodiment is configured to intermediate between the vehicle 2 (autonomous vehicle) and the facility 3 (target object) by using the coordination zone generated for each vehicle 2. Specifically, the integrated management system 1 according to the present embodiment defines, as the coordination zone, the reference distance for each vehicle 2 that varies with the operation information. In addition, the integrated management system 1 according to the present embodiment coordinates the vehicle 2 with the target object at a timing when the distance between the vehicle 2 and the target object becomes equal to or less than the reference distance, that is, at a timing when the vehicle 2 enters the coordination zone.

This configuration enables direct cooperation between an autonomous vehicle and an infrastructure facility while maintaining consistency with other vehicles traveling in the surroundings and with the operation plan. Therefore, according to the integrated management system 1 of the present embodiment, it is possible to cooperate with external objects such as the facility 3 including traffic signals, and transported cargo, and to appropriately manage the operation of autonomous vehicles. In other words, the integrated management system 1 according to the present embodiment enables efficiency and responsiveness to be achieved in the cooperation between the autonomous vehicle and the target object.

Moreover, with the above configuration, the final decision regarding traveling is made by both the vehicle 2 and the target object in cooperation, so that safety is ensured.

Additionally, with the above configuration, the integrated management system 1 according to the embodiment of the present disclosure can be applied while reusing existing connection and management methods for vehicles and target objects operated by other business providers.

Hereinafter, other embodiments of the present disclosure will be described. Note that, in the following descriptions of each embodiment, the differences will be mainly described, and repetition of the above contents will be omitted as appropriate.

### Second Embodiment

In the integrated management system 1 according to the embodiment mentioned above, it can be determined whether an update of a coordination zone is necessary, and the coordination zone can be dynamically changed with the status of the vehicle 2.

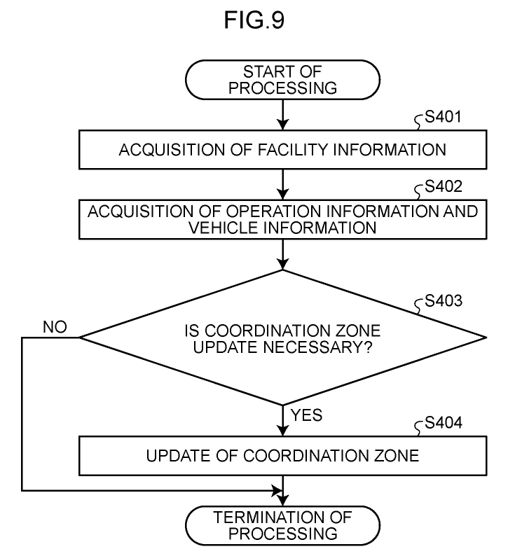

FIG. 9 is a flowchart illustrating an exemplary procedure of coordination zone update processing executed by the fleet management system 5 according to the embodiment.

The coordination zone management unit 56 acquires infrastructure information (S401). In addition, the coordination zone management unit 56 acquires operation information and vehicle information (S402). The coordination zone management unit 56 determines whether the coordination zone needs to be updated based on the operation information, the infrastructure information, and the vehicle information (S403). The coordination zone management unit 56 can determine that updating of a coordination zone is necessary when, for example, the operation plan is updated such as a case where a new vehicle 2 is added to the operation plan or where the business operation of the vehicle 2 is changed. When the coordination zone management unit 56 determines that updating of a coordination zone is necessary (S403: Yes), it generates a coordination zone for each of the vehicles 2 whose coordination zone needs to be updated (S404). When the coordination zone management unit 56 determines that updating of a coordination zone is not necessary (S403: No), or after updating a coordination zone in the processing step of S404, the procedure in FIG. 9 ends.

Note that the procedure in FIG. 9 can be executed separately from the procedure in FIG. 5, or can be executed during the processing steps of S201 to S203 before implementation of the operation plan in FIG. 5, or can be executed during the processing steps of S204 to S206 in implementation of the operation plan in FIG. 5, or can be executed in both the processing steps of S201 to S203 and the processing steps of S204 to S206. In the procedure in FIG. 5, the coordination zone management unit 56 can acquire the vehicle information from the vehicle management unit 52 and determine whether updating of a coordination zone is necessary based on the operation information, the infrastructure information, and the vehicle information.

The above-described configuration allows the coordination zone to be dynamically changed with the status of the vehicle 2, thereby enabling direct cooperation between autonomous vehicles and infrastructure facilities while maintaining consistency with current operation information.

### Third Embodiment

In the integrated management system 1 according to the embodiment mentioned above, a transmission source of the connection request can be the facility 3 instead of the vehicle 2.

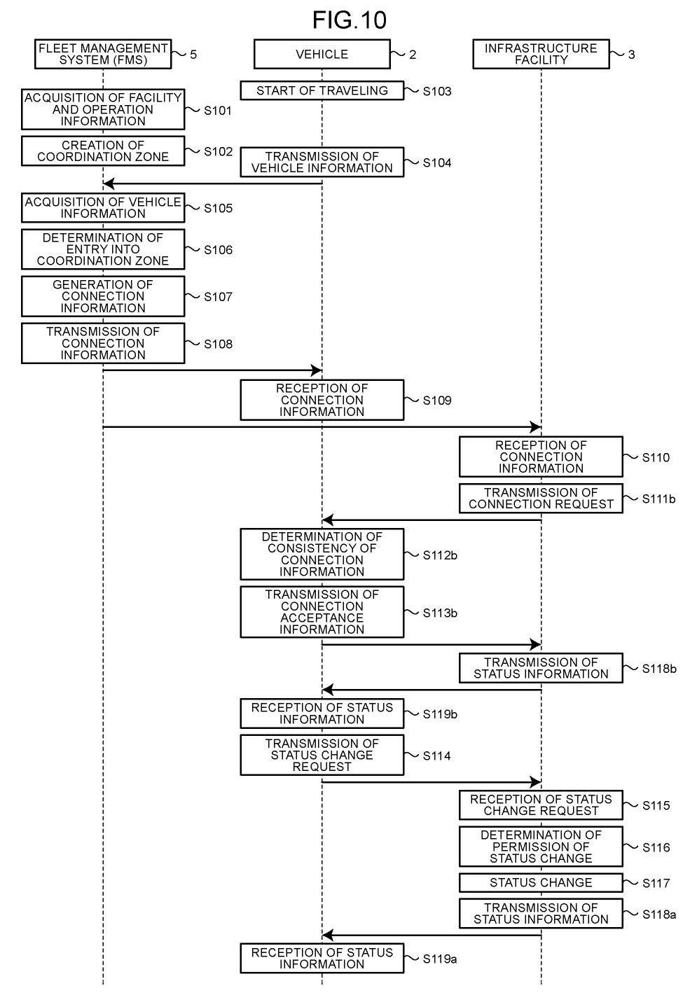

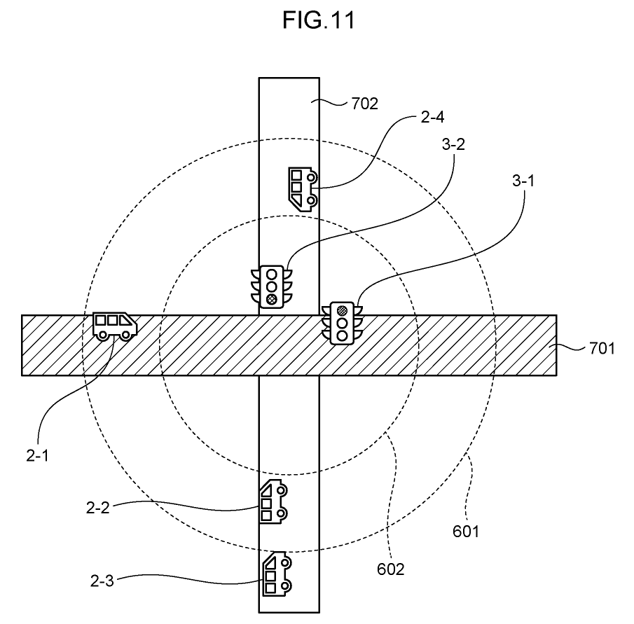

FIG. 10 is a sequence diagram illustrating another exemplary procedure of information processing executed by the fleet management system 5 according to the embodiment. In this example, differences from the procedure in FIG. 3 are mainly described. The facility 3, which has received connection information, transmits a connection request to the vehicle 2 in response to entry of the vehicle 2 into the coordination zone (S111b). Then, the vehicle 2, which has received the connection request, determines the consistency of the connection information (S112b). When the consistency is validated, the vehicle 2 transmits connection acceptance information to the facility 3 that transmitted the connection request, and establishes a connection with this facility 3 (S113b). In other words, the vehicle 2 that receives the connection information establishes communication with the relevant facility 3 (target object) based on the connection information. In addition, the facility 3, which has received the connection acceptance information, transmits status information to the vehicle 2 that transmitted the connection acceptance information (S118b). Then, after receipt of the status information from the facility 3 (S119b), the vehicle 2 executes the processing steps of S114 to S119a.

Note that the processing step of S118b, in which the facility 3 that received the connection acceptance information transmits status information prior to receiving a status change request, is not essential processing and may be omitted. Alternatively, in the procedure of FIG. 3, status information can be transmitted prior to receiving a status change request.

Moreover, the connection request can be transmitted from both of the vehicle 2 and the facility 3. In this case, the connection request can be transmitted when absence of having received the one, and an error signal may be returned in response to receiving the connection request after transmitting the one. In addition, the connection entity (i.e., the vehicle 2 or the facility 3) as the transmission source of the connection request can differ for each vehicle 2 or each facility 3.

Even with this configuration, it is possible to achieve effects similar to those of the embodiment mentioned above.

The following describes application examples of the present disclosure.

### First Application Example

FIG. 11 is a diagram illustrating an exemplary application scenario of the integrated management system 1 according to an embodiment. FIG. 11 illustrates a situation in which, beginning with the status illustrated in FIG. 4, a first vehicle 2-1 traveling toward an intersection on a first travel road 701 enters a coordination zone 601, and a second vehicle 2-2 traveling toward an intersection on a second travel road 702 is waiting for entry into a coordination zone 602. FIG. 11 also illustrates a situation that a third vehicle 2-3 is traveling toward an intersection on the second travel road 702 competing with the first travel road 701 on which the first vehicle 2-1 is traveling, and a fourth vehicle 2-4 is waiting for entry into the coordination zone 602.

As illustrated in FIG. 11, in some cases, there are multiple vehicles 2 that depend on the status of the same facility 3 (3-2), such as the second vehicle 2-2 and the third vehicle 2-3 on the same lane, and the fourth vehicle 2-4 on the opposite lane. In such cases, cooperation that considers overall priority and smooth traffic flow can be more effective than cooperation based solely on priority, which grants the right of connection to the first vehicle 2-1 with a higher priority. For example, as shown in FIG. 11, even in a situation that the first vehicle 2-1 with a higher priority is granted the right of connection, it can be preferable to allow multiple vehicles 2 to pass earlier when there are multiple vehicles 2 (2-2, 2-3, and 2-4) competing with the second travel road 702. However, even under the same situation, it is conceivable that an ambulance should be given priority regardless of the number of vehicles on the competing lane, and thus, the degree of urgency of the first vehicle 2-1 can become a factor.

Accordingly, the integrated management system 1 according to the embodiment of the present disclosure can be configured to assign multiple coordination zones to one vehicle 2. In other words, the integrated management system 1 according to the embodiment of the present disclosure can define multiple reference distances. In this case, a larger coordination zone can be set as a pre-request acceptance range, and a smaller coordination zone can be set as a range in which operation is initiated in accordance with the request (actual connection is permitted). This configuration makes it possible to establish a grace period until the start of an operation. It is also possible to define entry into a temporally defined zone as assigning priority and providing a temporal grace period until implementation.

Further, in the configuration above, the integrated management system 1 can assign a vehicle-count zone in addition to the coordination zone for each vehicle 2. In this case, upon entry of the vehicle 2 into the operation start range (coordination zone), the integrated management system 1 can determine whether to permit connection based on the number of vehicles in the vehicle-count zone. The vehicle count can be the number of vehicles approaching the same facility 3 in both the own lane and the competing lane. Note that the vehicle-count zone can be create in a manner similar to the coordination zone described above. In addition, the vehicle-count zone can have separate counts for the own lane and the competing lane, and determination can be made based on those counts. Furthermore, criteria for the number of vehicles to be counted can vary with the urgency of the task of the primary vehicle 2. Moreover, the vehicle count can also consider information regarding dwell time. Additionally, the vehicle count can be weighted for either the own lane or the competing lane. This configuration allows for dynamic changes in priority according to the number of vehicles on the competing lanes before entry into the operation start range.

### Second Application Example

In some cases, there is also a manually driven vehicle or a vehicle not under the management of the fleet management system 5. In a case of a manually driven vehicle, the route and operation plans are unknown, so that the fleet management system 5 sometimes is unlikely to accurately identify competing facilities such as traffic lights.

In the fleet management system 5, it is conceivable that it can be unclear whether a manually driven vehicle will obey a straight-ahead signal or a right-turn signal.

Therefore, the integrated management system 1 according to the embodiment of the present disclosure, in a case of performing only counting, allocate the count among the vehicles 2 corresponding to possible route cases, for example, by simply counting the vehicles 2 in the same lane. In addition, if a request is also issued from a manually driven vehicle, the fleet management system 5 in the integrated management system 1 according to the embodiment of the present disclosure can also manage the manually driven vehicle. In a case where the fleet management system 5 is able to manage the operation of a manually driven vehicle, it is possible to define a coordination zone in a similar manner to the above-described embodiments. Moreover, the fleet management system 5 can change the coordination zone by determining the vehicle type, such as determining whether the vehicle is a manual driving vehicle. Furthermore, in a case where there is a vehicle not managed by the fleet management system 5, the integrated management system 1 according to the embodiment of the present disclosure can virtually assume a coordination zone between a predetermined manually driven vehicle and the facility 3, and then set an appropriate zone corresponding to this virtual coordination zone as the coordination zone for the autonomous vehicle. Additionally, for example, in a case where the manually driven vehicle is a vehicle with a high level of urgency, the integrated management system 1 according to the embodiment of the present disclosure is capable of setting, for the autonomous vehicle, a smaller coordination zone than the predetermined coordination zone for the manually driven vehicle. With this configuration, even when there is a manually driven vehicle or a vehicle not under the management of the fleet management system 5, it is possible to cooperate with the facilities 3 such as traffic signals and external objects such as transported cargo, and thereby appropriately manage the operation of the autonomous vehicle.

### Third Application Example

When, for example, the first vehicle 2-1 and the second vehicle 2-2 do not interfere with each other, consideration of priority can be unnecessary, and an appropriate zone can be set to suppress unnecessary coordination. In this context, a case is considered where the coordination zone 601 of the first vehicle 2-1 is larger than the coordination zone 602 of the second vehicle 2-2. In addition, the elapsed time until the first vehicle 2-1 reaches the intersection is set as "Time A". Additionally, the elapsed time until the second vehicle 2-2 reaches the intersection is set as "Time B". The time for the vehicle 2 to pass through the intersection and for the status of the facility 3 to change is set as "Time C". In this case, if the relationship "(Time A - Time B) > Time C" is satisfied, the first vehicle 2-1 and the second vehicle 2-2 do not interfere with each other.

Accordingly, the integrated management system 1 according to the embodiment disclosed herein can set the coordination zone such that the difference between the maximum and minimum zones is equal to or less than "Time C". This makes it possible to suppress situations in which, despite there being no impact (interference), the second vehicle 2-2 is made to wait, thereby ensuring smooth operation.

### Fourth Application Example

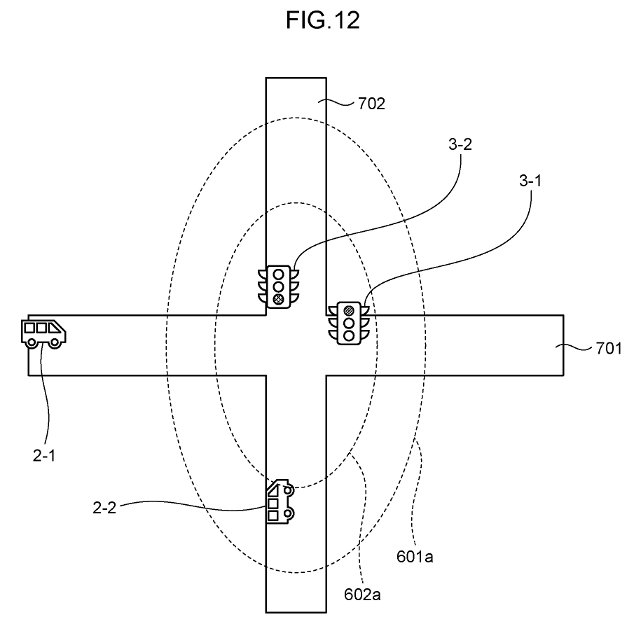

FIG. 12 is a diagram illustrating another exemplary application scenario for the integrated management system 1 according to an embodiment. FIG. 12 illustrates a case in which a coordination zone is defined according to road conditions. FIG. 12 exemplifies a first vehicle 2-1 traveling toward an intersection on a first travel road 701, and a second vehicle 2-2 traveling toward the intersection on a second travel road 702. In the example of FIG. 12, the second travel road 702 is a priority road, and the vehicle 2-2 traveling on the second travel road 702 is assumed to be prioritized over the vehicle 2-1 traveling on the first travel road 701 with respect to connection permission to the facility 3.

In such a case, the integrated management system 1 according to the embodiment of the present disclosure can define coordination zones 601a and 602a advantageous to the priority road (702). For example, as illustrated in FIG. 12, the integrated management system 1 according to the embodiment of the present disclosure can define an elliptical coordination zone extending along the priority road (702), that is, an ellipse whose major axis lies along the priority road. This configuration enables operation management that takes road priority into account by defining a coordination zone.

### Fifth Application Example

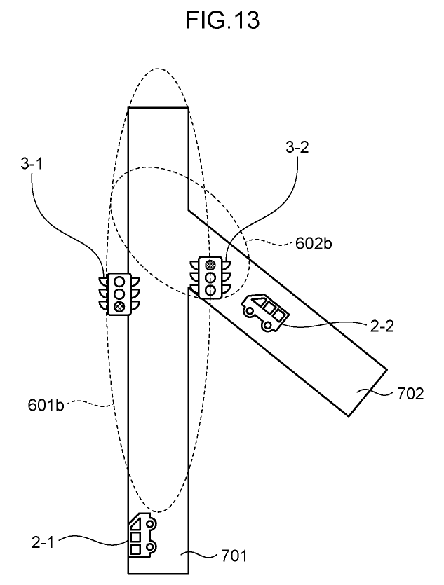

FIG. 13 is a diagram illustrating another exemplary application scenario of the integrated management system 1 according to an embodiment. FIG. 13 illustrates the case in which a coordination zone is defined based on road conditions. FIG. 13 exemplifies a first vehicle 2-1 traveling toward an intersection on a first travel road 701, and a second vehicle 2-2 traveling toward the intersection on a second travel road 702. FIG. 13 also exemplifies a T-shaped intersection where the second travel road 702 is laterally connected as a side road to the first travel road 701 serving as a main road. This configuration can be applied to merging intersections as well as T-shaped intersections. With regard to permission to connect to the facility 3, the vehicle 2-1 traveling on the first travel road 701 is given priority over the vehicle 2-2 traveling on the second travel road 702. Such priority can be based on the priority between travel roads or on traffic volume.

In such a case, the integrated management system 1 according to the embodiment of the present disclosure can define coordination zones 601b and 602b that are advantageous to the main travel road. For example, as illustrated in FIG. 13, the integrated management system 1 according to the embodiment of the present disclosure can define coordination zones that are elliptical and extend along the first main travel road 701 and the second side travel road 702, namely, define ellipses whose major axes lie along the respective travel roads with the main road side being defined with a larger coordination zone. This configuration enables operation management that takes road priority into account by defining the coordination zone.

Note that the above-described embodiments, modifications, and application examples can be combined in any manner.

Moreover, in the above-described embodiment, a determination of "whether or not A" can be implemented by determining only that "A is true", by determining only that "A is not true", or by determining the both.

Moreover, in the above-described embodiment, "any of A (plural) " refers to "at least one of A".

Moreover, a computer program executed by each device of the integrated management system 1 according to the above-described embodiment can be provided by being recorded on a non-transitory computer-readable recording medium such as a CD-ROM, an FD, a CD-R, or a DVD, in a file format installable or executable.

Further, the program executed by each device of the integrated management system 1 according to the above-described embodiment can be configured to be stored on a computer connected to a network such as the Internet and provided by allowing downloading via the network. In addition, the program executed by each device of the integrated management system 1 according to the above-described embodiment can be configured to be provided or distributed via a network such as the Internet.

Furthermore, the program executed by each device in the integrated management system 1 according to the above-described embodiment can be configured to be provided by being pre-installed in a ROM or the like.

According to at least one of the above-described embodiments, it is possible to achieve both efficiency and responsiveness in the cooperation between autonomous vehicles and target objects.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Notes

Through the foregoing description of embodiments, the following technologies are disclosed.

### (1)

An information processing method implemented by a computer of an information processing system, the information processing system serving to manage operation of autonomous vehicles traveling in a specific area in which one or more target objects are present, the method comprising:

acquiring operation information relating to the autonomous vehicles in the specific area;

defining a reference distance for each of the autonomous vehicles, the reference distance varying with the operation information;

acquiring position information of the autonomous vehicles being traveling; and

causing one of the autonomous vehicles and the target object to coordinate with each other, the one of the autonomous vehicles being an autonomous vehicle whose distance to the target object is equal to or less than the reference distance.

### (2)

The information processing method according to the above-described (1), further comprising:

acquiring infrastructure information including position information of each of the target objects in the specific area;

determining, based on the infrastructure information and the operation information, whether at least one of the target objects is present on a route of each of the autonomous vehicles; and

defining the reference distance in response to determining that at least one of the target objects is present on the route.

### (3)

The information processing method according to the above-described (1) or (2), wherein

the operation information includes task type information about the autonomous vehicles, and

the information processing method further comprises defining, as the reference distance, a length pre-associated with the task type information.

### (4)

The information processing method according to any one of the above-described (1) to (3), further comprising updating the reference distance when the operation information is updated.

### (5)

The information processing method according to any one of the above-described (1) to (4), further comprising:

transmitting connection information to both the target object and the one of the autonomous vehicles whose distance to the target object is equal to or less than the reference distance;

establishing, based on the connection information, connection between the autonomous vehicle and the target object each receiving the connection information; and

coordinating the one of the autonomous vehicles with the target object by transmitting a status change request for change of a status, the status change request

being transmitted from the one of the autonomous vehicles to the target object after the connection is established.

### (6)

The information processing method according to the above-described (5), further comprising:

by the one of the autonomous vehicles having received the connection information, transmitting a connection request to the target object based on the connection information; and,

by the target object having received the connection request,

determining consistency of the connection request based on the connection information, and

establishing communication with the one of the autonomous vehicles in response to determining that the connection request is consistent with the connection information.

### (7)

The information processing method according to the above-described (5), further comprising:

by the target object having received the connection information, transmitting a connection request to the target object based on the connection information; and,

by the one of the autonomous vehicles having received the connection request,

determining consistency of the connection request based on the connection information, and

establishing communication with the target object in response to determining that the connection request is consistent with the connection information.

### (8)

The information processing method according to the above-described (6) or (7), further comprising defining two or more of the reference distances for each of the autonomous vehicles, the two or more reference distances including:

a first reference distance at which a connection request based on the connection information is accepted, and

a second reference distance at which a connection is established in accordance with the connection request, the second reference distance being smaller than the first reference distance.

### (9)

An information processing device provided in a vehicle and communicable with an information processing system, the vehicle traveling in a specific area in which one or more target objects are present, the information processing system serving to manage operation of the vehicle, the information processing device comprising:

a memory in which a computer program is stored; and

a hardware processor connected to the memory and configured to perform processing by executing the computer program, the processing including

receiving connection information transmitted from the information processing system when a distance between the vehicle and the target object becomes equal to or less than a reference distance, the reference distance being defined for the vehicle based on operation information relating to the vehicle in the specific area,

establishing communication with the target object based on the connection information, and

coordinating with the target object by transmitting a status change request for change of a status to the target object after the connection is established.

### (10)

A non-transitory computer readable recording medium on which programmed instructions executable by a computer of an information processing system are recorded, the information processing system serving to manage operation of autonomous vehicles traveling in a specific area in which one or more target objects are present, the programmed instructions causing the computer to perform processing, the processing including:

acquiring operation information relating to the autonomous vehicles in the specific area;

defining a reference distance for each of the autonomous vehicles, the reference distance varying with the operation information;

acquiring position information of the autonomous vehicles being traveling; and

causing one of the autonomous vehicles and the target object to coordinate with each other, the one of the autonomous vehicles being an autonomous vehicle whose distance to the target object is equal to or less than the reference distance.

### (11)

An information processing device including:

at least one memory in which a computer program is stored; and

at least one processor connected to the memory and configured to implement the information processing method according to any one of (1) to (8) by executing the computer program.

### (12)

A computer program configured to cause a computer to execute the information processing method according to any one of (1) to (8), or

a non-transitory computer-readable storage medium storing the computer program.

What is claimed is:

1. An information processing method implemented by a computer of an information processing system, the information processing system serving to manage operation of autonomous vehicles traveling in a specific area in which one or more target objects are present, the method comprising:
acquiring operation information relating to the autonomous vehicles in the specific area;
defining a reference distance for each of the autonomous vehicles, the reference distance varying with the operation information;
acquiring position information of the autonomous vehicles being traveling; and
causing one of the autonomous vehicles and the target object to coordinate with each other, the one of the autonomous vehicles being an autonomous vehicle whose distance to the target object is equal to or less than the reference distance.

2. The information processing method according to claim 1, further comprising:
acquiring infrastructure information including position information of each of the target objects in the specific area;
determining, based on the infrastructure information and the operation information, whether at least one of the target objects is present on a route of each of the autonomous vehicles; and
defining the reference distance in response to determining that at least one of the target objects is present on the route.

3. The information processing method according to claim 1, wherein
the operation information includes task type information about the autonomous vehicles, and
the information processing method further comprises defining, as the reference distance, a length pre-associated with the task type information.

4. The information processing method according to claim 1, further comprising updating the reference distance when the operation information is updated.

5. The information processing method according to claim 1, further comprising:
transmitting connection information to both the target object and the one of the autonomous vehicles whose distance to the target object is equal to or less than the reference distance;
establishing, based on the connection information, connection between the autonomous vehicle and the target object each receiving the connection information; and
coordinating the one of the autonomous vehicles with the target object by transmitting a status change request for change of a status, the status change request being transmitted from the one of the autonomous vehicles to the target object after the connection is established.

6. The information processing method according to claim 5, further comprising:
by the one of the autonomous vehicles having received the connection information, transmitting a connection request to the target object based on the connection information; and,
by the target object having received the connection request,
determining consistency of the connection request based on the connection information, and
establishing communication with the one of the autonomous vehicles in response to determining that the connection request is consistent with the connection information.

7. The information processing method according to claim 5, further comprising:
by the target object having received the connection information, transmitting a connection request to the target object based on the connection information; and,
by the one of the autonomous vehicles having received the connection request,
determining consistency of the connection request based on the connection information, and
establishing communication with the target object in response to determining that the connection request is consistent with the connection information.

8. The information processing method according to claim 5, further comprising defining two or more of the reference distances for each of the autonomous vehicles, the two or more reference distances including:
a first reference distance at which a connection request based on the connection information is accepted, and
a second reference distance at which a connection is established in accordance with the connection request, the second reference distance being smaller than the first reference distance.

9. An information processing device provided in a vehicle and communicable with an information processing system, the vehicle traveling in a specific area in which one or more target objects are present, the information processing system serving to manage operation of the vehicle, the information processing device comprising:
a memory in which a computer program is stored; and
a hardware processor connected to the memory and configured to perform processing by executing the computer program, the processing including
receiving connection information transmitted from the information processing system when a distance between the vehicle and the target object becomes equal to or less than a reference distance, the reference distance being defined for the vehicle based on operation information relating to the vehicle in the specific area,
establishing communication with the target object based on the connection information, and
coordinating with the target object by transmitting a status change request for change of a status to the target object after the connection is established.

10. A non-transitory computer readable recording medium on which programmed instructions executable by a computer of an information processing system are recorded, the information processing system serving to manage operation of autonomous vehicles traveling in a specific area in which one or more target objects are present, the programmed instructions causing the computer to perform processing, the processing including:
acquiring operation information relating to the autonomous vehicles in the specific area;
defining a reference distance for each of the autonomous vehicles, the reference distance varying with the operation information;
acquiring position information of the autonomous vehicles being traveling; and
causing one of the autonomous vehicles and the target object to coordinate with each other, the one of the autonomous vehicles being an autonomous vehicle whose distance to the target object is equal to or less than the reference distance.
